(19) United States
(12) Patent Application Publication
(10) Pub. No.: US 2015/0245452 A1
(43) Pub. Date: Aug. 27, 2015

(54) Power-Saving Lighting Apparatus

(71) Applicant: STAR-REACH CORP., New Taipei City (TW)

(72) Inventor: Chih-Chien YEN, New Taipei City (TW)

(21) Appl. No.: 14/452,541

(22) Filed: Aug. 6, 2014

(30) Foreign Application Priority Data
Feb. 24, 2014 (TW) 103106085
Jun. 17, 2014 (TW) 103120870

(51) Int. Cl. H05B 37/02; H05B 33/08

(52) U.S. Cl. CPC H05B 37/0281; H05B 33/0845; H05B 33/086

(57) ABSTRACT

A power-saving lighting apparatus is provided, and includes at least one light source, at least one driver, a controller and a memory. The driver is coupled with the light source. The controller is coupled with the driver. The memory with a time table is coupled with the controller. The time table records lighting-up time periods and their corresponding brightness data of the light source. The controller controls the light source according to the lighting-up time periods and their corresponding brightness data.

### RELATED APPLICATIONS

This application claims priority to Taiwan Application Serial Number 103106085, filed Feb. 24, 2014 and Serial Number 103120870, filed Jun. 17, 2014, which is herein incorporated by reference.

### BACKGROUND

1. Field of Invention

The invention relates to a lighting apparatus, and particularly relates to a power-saving lighting apparatus.

2. Description of Related Art

Typically, to reveal features of a building, a lot of lighting is provided on the exterior of the building. Although the lighting enrich the city night scene, the power waste as well as the light pollution are resulted in because the light is still on at night even if there are few pedestrians at night. On the other hand, some buildings will turn off their lighting for saving power, thus not only destroying the city night scene but also losing the original purpose of providing lighting on the buildings.

Therefore, there is a need to develop a lighting apparatus to save power and reduce the light pollution at night.

### SUMMARY

An aspect of the present invention provides a power-saving lighting apparatus. The power-saving lighting apparatus comprises at least one light source, at least one driver, a controller and a memory. The driver is coupled with the light source. The controller is coupled with the driver. The memory with a time table is coupled with the controller. The time table records lighting-up time periods and their corresponding brightness data of the light source. The controller controls the light source according to the lighting-up time periods and their corresponding brightness data.

In an embodiment, the light source is a LED.

In an embodiment, the light source comprises a plurality of sets of light source with the same color, different colors or different color temperatures.

In an embodiment, the power-saving lighting apparatus further comprises a controlling line coupled with the controller to renew the time table.

In an embodiment, the controller uses a power supply period as a basis for counting time to turn on the light source according to the lighting-up time periods and their corresponding brightness data in the time table.

In an embodiment, the controller uses a clock of the controller as a basis for counting time to turn on the light source according to the lighting-up time periods and their corresponding brightness data in the time table.

In an embodiment, the controller outputs PWM (Pulse Width Modulation) signals to the driver to turn on the light source.

In an embodiment, the controller outputs a voltage to the driver to turn on the light source.

In an embodiment, the light source is controlled to be gradually changed to a brightness corresponding to a next lighting-up period of time.

In an embodiment, a dc power source couples with the controller, the data recorded in the time table is generated by applying the dc power source or cutting off the dc power source to the controller to write the data to the memory.

In an embodiment, an ac power source couples with the controller, the data recorded in the time table is generated by turning on or turning off the ac power source supplied to the controller at least one period to write the data to the memory.

In view of the above, a time table is disposed in the power-saving lighting apparatus to record the lighting-up time periods and their corresponding brightness data. According to the time table, a controller may controls the light sources to be turned on/off in different brightness in different time periods to achieve power saving as well as the lighting purpose of enriching the city night scene

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of a power-saving lighting according to an embodiment of the invention;

FIG. 2 illustrates a time sequence diagram for adjusting the brightness of the lighting according to an embodiment of the invention; and

FIG. 3 illustrates a schematic diagram of a power-saving lighting according to another embodiment of the invention.

### DETAILED DESCRIPTION

Specific embodiments of the invention are described in details as follows with reference to the accompanying drawings, wherein throughout the following description and drawings, the same reference numerals refer to the same or similar elements and are omitted when the same or similar elements are stated repeatedly.

The present invention provides a power-saving lighting apparatus. A controller and a time table are embedded in the power-saving lighting apparatus. The controller controls this light sources to be turned on in different brightness in different time periods according to this time table, so as to achieve power saving as well as the purpose of enriching the city night scene. Moreover, light sources with different colors and different color temperatures are disposed in the power-saving lighting apparatus. Then, the color or color temperature of the power-saving lighting apparatus may be adjusted to enrich the appearance of a building.

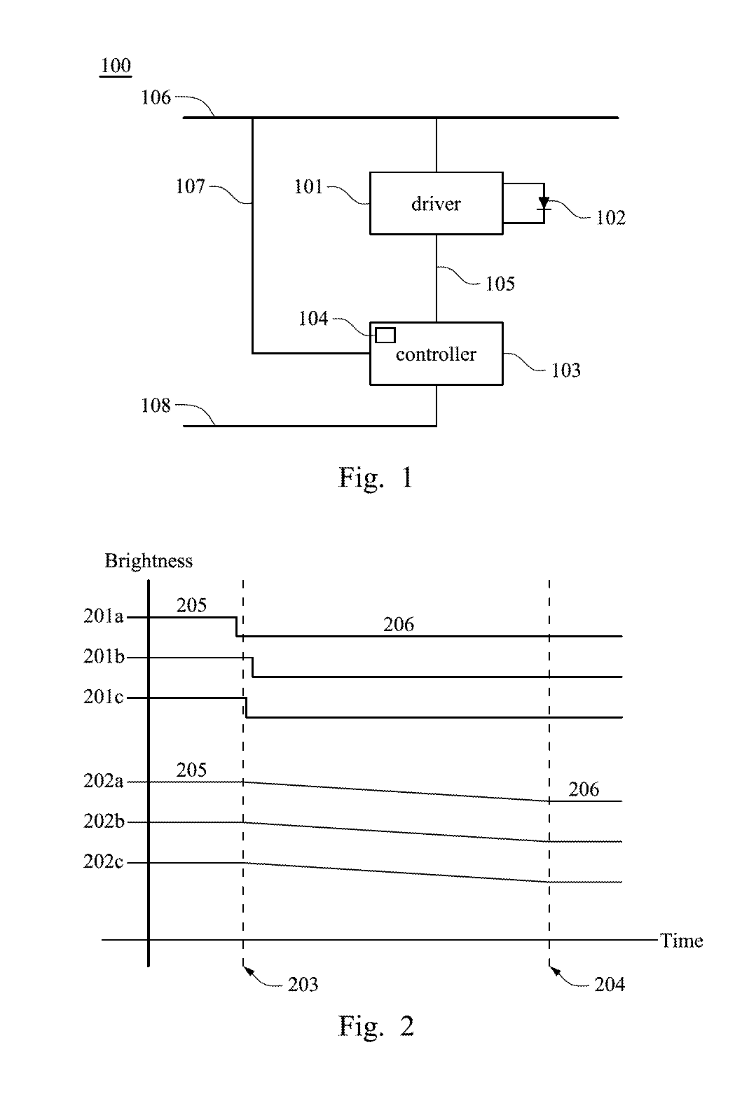

FIG. 1 illustrates a schematic diagram of a power-saving lighting apparatus 100 according to an embodiment of the invention. The power-saving lighting apparatus 100 comprises a driver 101, a set of light source 102, a controller 104 and a memory 104 for storing a time table. In an embodiment, the light source 102 is a LED. However, in another embodiment, other types of light sources also may be used in the present invention. Light sources 102 with different power levels and numbers are selected according to different usage places. These light sources 102 can have different colors or different color temperatures. For example, the light sources 102 comprises a plurality of sets of light source with the same color, different colors or different color temperatures or a LED with cool light and a LED with warm light. The arrangement of the light sources 102 is not be limited to the embodiment of the present invention. Moreover, the driver 101 is a standard LED driver. However, drivers with different specifications can be used in the present invention for collaborating with the power of the LED or the function of the power-saving lighting apparatus. The arrangement of the driver 101 is not be limited to the embodiment of the present invention. The controller 103 is a microcontroller unit (MCU). The memory 104 is disposed inside or outside the controller 103. A time table is stored in the memory 104 to record the lighting-up time periods and their corresponding brightness data of the light sources 102. The controller 103 may turn on the light sources 102 according to the time table. Because the controller 103 has a clock or a detector to detect the period of alternating current (AC), the firmware of the controller 103 may count time according the dock or the detected period of alternating current (AC). Then, the controller may turn on the light sources 102 according to the time and the lighting-up time periods and their corresponding brightness data recorded in the time table.

In an embodiment, these data of the time and the lighting-up time periods and their corresponding brightness is generated by applying or cutting off the power source supplied to the controller. For example, when a dc power source is used to supply power to the controller 103, the data recorded in the time table is generated by applying the dc power source or cutting off the dc power source to the controller. When the dc power source is applied to the controller 103, the data is “1”. When the dc power source is cut off to the controller 103, the data is “0”. Accordingly, by continuously applying or cutting off the dc power source to the controller 103, the controller 103 may write the data of the time table to the memory 104. On the other hand, when an ac power source is used to supply power to the controller 103, the data recorded in the time table is generated by turning on or turning off the ac power source supplied to the controller 103 one to a plurality of periods. When the ac power source is turning on for one period to the controller 103, the data is “1”. When the ac power source is turning on for two periods to the controller 103, the data is “11”. The rest may be deduced by analogy. On the other hand, when the ac power source is turning off for one period to the controller 103, the data is “0”. When the ac power source is turning off for two periods to the controller 103, the data is “00”. The rest may be deduced by analogy. Accordingly, by continuously turning on or turning off the ac power source supplied to the controller 103, the controller 103 may write the data of the time table to the memory 104. It is noticed that the foregoing description of the corresponding relationship of data does not limit the claimed invention. For example, in another embodiment, when the power source is applied to the controller 103, the data is “0”. When the power source is cut off with the controller 103, the data is “1”. Or, when the ac power source is turning on for two periods to the controller 103, the data is “1”. The user may define the corresponding relationship of data by himself.

The power-saving lighting apparatus 100 further comprises a first controlling line 105, a second controlling line 106, a third controlling line 107 and a fourth controlling line 108. The first controlling line 105 is disposed between the driver 101 and the controller 103. According the driving method of the driver 101, the controller 103 transmits analog signals or digital signals (PWM signals) to the driver 101 through the first controlling line 105. In an embodiment, if the driver 191 controls the brightness of the light sources 102 by using a current-adjusting method, the controller 103 transmits analog signals to the driver 101 through the first controlling line 105. In an embodiment, the controller 103 may output a voltage corresponding to the required brightness, such as 0˜5V corresponding to 0˜100% brightness respectively, to the driver 101 to adjust the brightness of the light sources 102. In other words, the controller 103 only needs to output different voltages to the driver 101 through the first controlling line 105 according to the required brightness recorded in the time table. In contrast, if the driver 101 controls the brightness of the light sources 102 by adjusting the period to turn on the light sources, the controller 103 transmits digital signals to the driver 101 through the first controlling line 105. In an embodiment, the controller 103 may output a pulse width modulation signal with a pulse width corresponding to the required brightness to the driver 101 to adjust the brightness of the light sources 102. In other words, the controller 103 only needs to output PWM signal to the driver 101 through the first controlling line 105 according to the required brightness recorded in the time table. The second controlling line 106 is coupled with a power supply to provide power to the power-saving lighting apparatus 100. The third controlling line 107 is coupled with the second controlling line 106 to gather the period of the AC supplied by the power supply to serve as the basis for counting time. The controller 103 controls the driver 101 to turn on the light sources 102 according to the time table. The fourth controlling line 108 is coupled with the controller 103 to serve as a signal line to write data to the memory 104. That is, the time table in the memory 104 may be renewed by the fourth controlling line 108 to change the lighting-up time periods and their corresponding brightness data. It is noted that, in an embodiment, the time table is predefined in the memory 104. However, in another embodiment, the time table is written into the memory 104 through the fourth controlling line 108 by a writing apparatus according to the usage situation after the power-saving lighting apparatus 100 is manufactured.

In an embodiment, according to the time table, the light sources 102 are turned on at 1800, and the corresponding brightness is 100% in the time period of 18:00˜21:00, and the corresponding brightness is 60% in the time period of 21:00˜24:00, and the corresponding brightness is 30% in the time period of 24:00˜6:00. Accordingly, the controller 103 turns on the light sources 102 at 18:00 and controls the light sources 102 to be maintained at 100% brightness in the time period of 18:00˜21:00. Next, the controller 103 reduces the output voltage or the turning-on period of the PWM signal to reduce the brightness (from 100% brightness to 60% brightness) of the light sources 102 at 18:00, and controls the light sources 102 to be maintained at 60% brightness in the time periods of 21:00˜24:00. Then, the controller 103 reduces the output voltage or the turning-on period of the PWM signal to reduce the brightness (from 60% brightness to 30% brightness) of the light sources 102 at 24:00, and controls the light sources 102 to be maintained at 30% brightness in the time period of 24:00˜6:00. According to this embodiment, the controller 103 controls the light sources 102 to be maintained at 100% brightness so as to enrich the city night scene in the time period of 18:00˜21:00 when there are a lot of people on the street. Then, the controller 103 controls the light sources 102 to be maintain at 60% brightness so as to save power in the time period of 21:00˜24:00 when the people start to leave the city and go home. Finally, the controller 103 controls the light sources 102 to be maintain at 30% brightness so as to reduce the light pollution and further save the power in the time period of 24:00˜6:00 when most people are in sleep. It is noted that a user may renew the time table in the memory 104 to change the above lighting-up time periods and corresponding brightness data through the fourth controlling line 108 according to the usage situation. On the other hand, a user may renew the time table in the memory 104 by continuously turning on or off the power source supplied to the controller 103. The above embodiment does not intend to limit the present invention. On the other hand, when the light sources 102 have different color temperatures, the light sources 102 with different temperatures may be controlled respectively. For example, the light sources 102 with a cool color temperature are turned on in the time period of 18:00˜20:00. The light sources 102 with a middle color temperature are turned on in the time period of 20:00˜22:00. The light sources 102 with a warm color temperature are turned on in the time period of 22:00˜24:00. After 24:00, the brightness of the light sources 102 with a warm color temperature is gradually reduced until to 6:00.

On the other hand, the control speed of each controller 103 is different. Therefore, time differences among the controllers will be generated after a long-term operation. The time differences will cause the light sources 102 controlled by different controllers 103 to be turned on and off at different time points, thus affecting the brightness of a building even though the same time table is used by the controllers 103. For solving the above problems, the light sources 102 are adjusted gradually. For example, the brightness of the light sources 102 is changed from 100% brightness to 60% brightness gradually in three minutes. Because the brightness is not changed abruptly, the brightness difference problem resulted from the time differences can be solved.

FIG. 2 illustrates a time sequence diagram for adjusting the brightness of the lighting according to an embodiment of the invention. The horizontal axis is a time axis and the vertical axis is a brightness axis. The curves 201a, 201b and 201c respectively represent the brightness states outputted from three power-saving lighting apparatus that are changed according to the same time table. Because the control speeds of controllers 103 disposed in the three power-saving lighting apparatus are different, the time points for the three power-saving lighting apparatus to switch their brightness from brightness 205 to brightness 206 will be different. For example, the brightness of the curve 201a is switched before the time point 203. The brightness of the curves 201b and 201c is switched after the time point 203. When the time differences for the power-saving lighting apparatus to switch the brightness are too large, a user may sense the brightness differences. On the other hand, the curves 202a, 202b and 202c respectively represent the brightness states outputted from three power-saving lighting apparatus that are gradually changed according to the same time table. In this case, the brightness is gradually changed from brightness 205 to brightness 206 between the time point 203 to the time point 204. Therefore, the brightness difference is little although control speeds of controllers 103 disposed in the three power-saving lighting apparatus are different. For example, the brightness is gradually changed from brightness 205 (100% brightness) to brightness 206 (60% brightness) in 10 minutes (from the time point 203 to the time point 204). Accordingly, the brightness difference among the power-saving lighting apparatus in each second will be 6.66% (=40%/(10*60 seconds)), which is a small difference of brightness. Therefore, it is very difficult for a user to sense such a small difference of brightness. Therefore, the method of gradually adjusting brightness may solve the brightness difference problem.

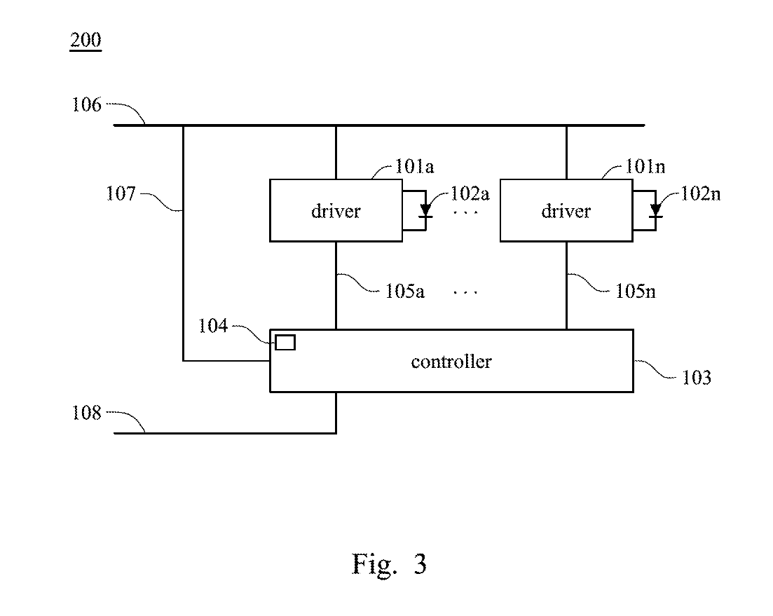

FIG. 3 illustrates a schematic diagram of a power-saving lighting apparatus according to another embodiment of the invention. The main different between the present embodiment and the above embodiment is that the controller 103 disposed in the power-saving lighting apparatus 200 controls many drivers 101a to 101n to drive light sources 102a to 102n respectively. The light sources 102a to 102n are grouped into many groups of light sources with the same color, different colors or different color temperatures. For example, the light source is a LED. The light sources 102a to 102n are grouped into two groups of light sources, in which one group includes LEDs with cool white light and another group includes LEDs with warm white light. By arranging different LEDs in the power-saving lighting apparatus 200, the power-saving lighting apparatus 200 may generate light with different color temperatures and brightness. Moreover, the power-saving lighting apparatus 200 further comprises first controlling lines 105a to 105n, a second controlling line 106, a third controlling line 107 and a fourth controlling line 108. The first controlling lines 105a to 105n are disposed between the drivers 101a to 101n and the controller 103. The controller 103 transmits analog signals or digital signals, PWM signals, to the drivers 101a to 101n through the first controlling lines 105a to 105n respectively. The second controlling line 106 is coupled with a power supply to provide power to the power-saving lighting apparatus 200. The third controlling line 107 coupled with the second controlling line 106 is used to gather the period of the AC supplied by the power supply as a basis for counting time. The controller 103 controls the drivers 101a to 101n to turn on the light sources 102a to 102n according to the time table. The fourth controlling line 108 is coupled with the controller 103 to serve as a signal line to write data into the memory 104. That is, the time table in the memory 104 may be renewed by the fourth controlling line 108 so as to change the lighting-up time periods and their corresponding brightness data. It is noted that, in an embodiment, the time table is predefined in the memory 104. However, in another embodiment, the time table is written into the memory 104 through the fourth controlling line 108 by a writing apparatus according to the usage situation after the power-saving lighting apparatus 200 is manufactured. In further embodiment, the time table is written into the memory 104 by continuously turning on or off the power source supplied to the controller 103.

In view of the above, a time table is disposed in the power-saving lighting apparatus to record the lighting-up time periods and their corresponding brightness data. According to the time table, a controller may controls the light sources to be turned on/off in different brightness in different time periods, so as to achieve power saving as well as the lighting purpose of enriching the city night scene. Moreover, light sources with different colors and different color temperatures are disposed in the power-saving lighting apparatus. Then, the color or color temperature of the power-saving lighting apparatus may be adjusted to enrich the appearance of a building.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. A power-saving lighting apparatus, comprising:
a light source;
a driver coupled with the light source;
a controller coupled with the driver; and
a memory with a time table coupled with the controller, wherein the time table records a data that comprises lighting-up time periods and their corresponding brightness data of the light source, and the controller controls the light source according to the lighting-up time periods and their corresponding brightness data.

2. The power-saving lighting apparatus of claim 1, wherein the light source is a LED (Light-Emitting Diode).

3. The power-saving lighting apparatus of claim 1, wherein the light source comprises a LED with cool light and a LED with warm light.

4. The power-saving lighting apparatus of claim 1, wherein the light source comprises a plurality of sets of light sources with the same color, different colors or different color temperatures.

5. The power-saving lighting apparatus of claim 1, further comprising a controlling line coupled with the controller to renew the time table.

6. The power-saving lighting apparatus of claim 1, wherein the controller uses a power supply period as a basis for counting time so as to turn on the light source according to the lighting-up time periods and their corresponding brightness data in the time table.

7. The power-saving lighting apparatus of claim 1, wherein the controller uses a clock of the controller as a basis for counting time so as to turn on the light source according to the lighting-up time periods and their corresponding brightness data in the time table.

8. The power-saving lighting apparatus of claim 1, wherein the controller outputs PWM (Pulse Width Modulation) signals to the driver to turn on the light source.

9. The power-saving lighting apparatus of claim 1, wherein the controller outputs a voltage to the driver to turn on the light source.

10. The power-saving lighting apparatus of claim 1, wherein the light source is controlled to be gradually changed to a brightness corresponding to a next lighting-up time of period.

11. The power-saving lighting apparatus of claim 1, further comprising a dc power source coupling with the controller, wherein the data recorded in the time table is generated by applying the dc power source or cutting off the dc power source to the controller to write the data to the memory.

12. The power-saving lighting apparatus of claim 1, further comprising an ac power source couples with the controller, the data recorded in the time table is generated by turning on or turning off the ac power source supplied to the controller at least one period to write the data to the memory.
